(19) United States
(12) Patent Application Publication
(10) Pub. No.: US 2026/0120320 A1
(43) Pub. Date: Apr. 30, 2026

(54) USING IMAGE ALIGNMENT FOR FLY CAPTURE WITH PHOTOMETRIC STEREO

(71) Applicant: UnitX, Inc., Santa Clara, CA (US)

(72) Inventors: Kyle Patrick Brocklehurst, Redwood City, CA (US); Killian Weber, Redwood City, CA (US); Martin Invaldsen, Santa Clara, CA (US); Max Zheng, Santa Clara, CA (US)

(21) Appl. No.: 18/934,054

(22) Filed: Oct. 31, 2024

(51) Int. Cl. G06T 7/80; G06T 7/00; G06T 7/13; G06T 7/38; G06T 7/586

(52) U.S. Cl. CPC G06T 7/80; G06T 7/0004; G06T 7/13; G06T 7/38; G06T 7/586; G06T 2207/10016

(57) ABSTRACT

In an example embodiment, a calibration phase is performed where a calibration object is sent through the system and multiple images of the calibration object are taken. From these images, the direction and speed of the calibration object can be computed as well as the distance between the calibration object and the camera. From these three pieces of information, a three-dimensional offset vector is created. This three-dimensional offset vector can then be applied during a photometric stereo process to align the object in the different images so that the orientation and graduation of the surface can be accurately calculated.

### TECHNICAL FIELD

This application relates generally to inspection camera assemblies. More particularly, this application relates to a lighting controller with noise and signal isolation for use in inspection camera assemblies.

### BACKGROUND

Inspection cameras are used in industrial products to aid in detecting defects in manufactured products. For example, if a manufacturer is producing metal castings, one or more inspection cameras may be placed in a manufacturing and/or assembly line to inspect the produced metal castings, or portions thereof, to detect any issues with quality control. An inspection camera assembly may include a camera mounted to or near multiple independently controlled light sources. These light sources may be activated in a coordinated sequence that is controlled by a lighting controller, to light the manufactured product from different angles and different times.

### BRIEF DESCRIPTION OF DRAWINGS

FIG. 1 illustrates a block diagram of an inspection system according to some examples.

FIG. 2 is a diagram illustrating an example of a calibration object, in accordance with an example embodiment.

FIGS. 3A-3H are example images taken during calibration of an inspection system using a calibration object 200, in accordance with an example embodiment.

FIG. 4 is a flow diagram illustrating a method for operating a controller, in accordance with an example embodiment.

FIG. 5 is a block diagram illustrating a mobile device, according to an example embodiment.

FIG. 6 is a block diagram of machine in the example form of a computer system within which instructions may be executed for causing the machine to perform any one or more of the methodologies discussed herein.

### DETAILED DESCRIPTION

Fly capture in inspection contexts, particularly in industrial or quality control settings, refers to a technique used to detect and measure defects, flaws, or issues on a surface of an object without the object coming to a halt in front of the camera. In other words, the object can be moving, such as on a conveyor belt, when the inspection is performed.

The technique is useful in environments where high-speed inspection is required. It can quickly capture and analyze data from fast-moving objects or processes, making it suitable for automated inspection systems.

Fly capture often uses advanced imaging or scanning technology to provide precise measurements and detailed images of surfaces. This high level of detail helps in identifying small or subtle defects that could affect the quality or performance of a product.

In order to generate an accurate three-dimensional computer representation of the surface of an object, it is often desirable to take multiple different images of the object, from different angles and under different lighting conditions. When trying to do this in a fly capture scenario, however, it is difficult to achieve high accuracy because it can be difficult to align the multiple images so that the system knows where each part of the object is in each of the images. For example, if an object has a small bump on it, that bump could appear in different locations in each of the images since the object is moving, and also because the relative position and orientation of the conveyor belt and the camera can make the perspective of the images be different from image to image. In other words, it is not just a matter of finding a particular object part in one image and lining that up with that same particular object part in another image because the two images may have different perspectives, and thus other parts of the same object can wind up being unaligned even if one were to align the particular object part.

In an example embodiment, a calibration phase is performed where a calibration object is sent through the system and multiple images of the calibration object are taken. From these images, the direction and speed of the calibration object can be computed as well as the distance between the calibration object and the camera. From these three pieces of information, a three-dimensional offset vector is created. This three-dimensional offset vector can then be applied during a photometric stereo process to align the object in the different images so that the orientation and graduation of the surface can be accurately calculated.

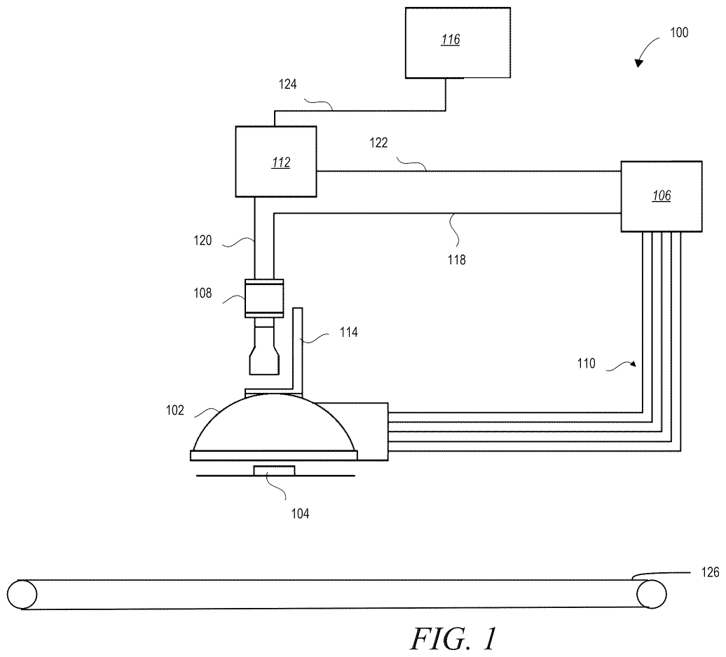

FIG. 1 illustrates a block diagram of an inspection system 100 according to some examples. The inspection system 100 includes a light dome 102, a camera 108, a controller 106, an industrial computer 112, and a factory computer 116. The factory computer 116 is in communication with the computer 112 via a wired or wireless factory network 124.

The light dome 102 in use illuminates a target object 104, such as a metal casting or other product. The light dome 102 includes a housing containing a number of light sources as will be described in more detail below. In some examples, the light sources comprise a plurality of LEDs or display screens arranged to provide flexibility in illuminating the target object 104. The light sources are selectively activated by the controller 106 using power cables 110. A light source is a unit of lighting that is individually addressable by the controller 106 to illuminate the target object 104. An individual light source may thus comprise a single LED or a number of LEDs that are addressable as a group. A light source may also comprise a subset of a light generating unit, such as a group or block of pixels in a flexible display screen. Preferably the light dome 102 includes at least ten individually addressable light sources arranged within the light dome 102, to provide lighting flexibility.

The camera 108, which may be mounted to the light dome 102 by a bracket 114, captures images of the illuminated target object 104 through a hole in the top of the light dome 102. The camera 108 is triggered by the controller 106 via a trigger line 118, synchronized to the actuation of the light sources in light dome 102.

The controller 106 controls operation of the camera 108 and illumination of the target object 104 by the light dome 102. The controller 106 receives instructions from the computer 112 via a control line 122. The controller 106 may be implemented by a hardware processor disposed in the camera 108. The controller 106 may further include hardware components that may include a combination of Central Processing Units (“CPUs”), buses, volatile and non-volatile memory devices, storage units, non-transitory computer-readable media, data processors, processing devices, control devices transmitters, receivers, antennas, transceivers, input devices, output devices, network interface devices, and other types of components that are apparent to those skilled in the art. These hardware components within the user device may be used to execute the various applications, methods, or algorithms disclosed herein independent of other devices disclosed herein.

The controller 106 illuminates the target object according to one or more optimal lighting configurations. The lighting configurations may be defined as a matrix, where each value of the lighting configuration matrix represents a working status of each independently controllable light source, such as one or more LEDs and/or groups of pixels on a flexible display screen. The matrix may also include brightness or color values for particular configurations. The lighting configurations may also be arranged into a configuration sequence, which specifies an order of lighting configurations to be executed for a particular target object 104, such that a number of images under different lighting conditions are captured by the camera 108.

The computer 112 runs software that provides a user interface that can be used to specify lighting configurations and sequences, which can be loaded into the controller 106. The computer 112 also instructs operation of the controller 106 via the control line 122, and receives images captured by the camera 108 via a data line 120.

The factory computer 116 provides overall factory control and can receive operational data and captured images from the computer 112 via the factory network 124. The factory computer 116 can also provide instructions to control or initiate operation of the inspection system 100, based for example on other factory operations such as the movement of target objects 104 past the light dome 102.

An object may be placed on a conveyor belt 126 and the conveyor belt 126 may move, causing the object to move so that it is at least somewhat under the camera 108 while one or more light sources on the light dome 102 are illuminated. As mentioned before, this may be performed under fly capture conditions, where the conveyor belt 126 does not stop and thus where the object does not stop under the camera 108. Instead, multiple images of the object are captured from different angles and under different light conditions, but instead of the camera 108 moving around the object to capture these different angles the object moves while the camera 108 stays fixed.

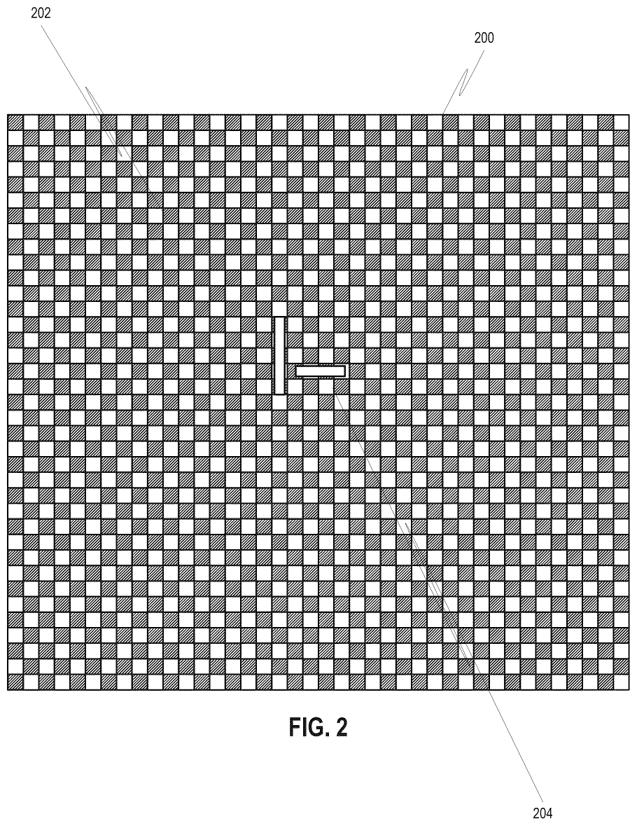

As mentioned earlier, a calibration operation is first performed in order to achieve image alignment when the multiple images of an actual part is performed for defect detection. During this calibration a calibration object is passed through the inspection system via the conveyor belt 126. In an example embodiment, the calibration object is an opal glass checkerboard having a center pattern that is distinct from the checkerboard. It should be noted that the checkerboard-based calibration object is merely one possible type of calibration object that can be used and nothing in this disclosure shall be interpreted as limiting the scope of protection only to a checkerboard-based calibration object, unless expressly indicated. FIG. 2 is a diagram illustrating an example of a calibration object 200, in accordance with an example embodiment. As mentioned, the calibration object 200 is an opal glass checkerboard. Since it is glass, it has a semi-reflective surface that acts to reflect light from one or more light sources.

As can be seen, the calibration object 200 is substantially a checkerboard pattern 202, although a distinct marker pattern 204 is placed at a point on the calibration object 200. In some example embodiments this distinct marker pattern 204 is placed in the center of the calibration object 200, but this is not strictly necessary.

The distinct marker pattern 204 can be any pattern that is distinguishable from the checkerboard pattern 202. Here, for example, the distinct marker pattern 204 is a series of horizontal and vertical lines, in contrast with the diagonal lines of the checkerboard pattern 202.

During calibration, the calibration object 200 is passed through the inspection system, with the camera capturing an image of the calibration object 200 at different times as the calibration object 200 moves underneath the camera (i.e., fly capture). The light sources are also alternated during these captures so that the images capture reflect the calibration object 200 not only from different angles but also under different lighting conditions.

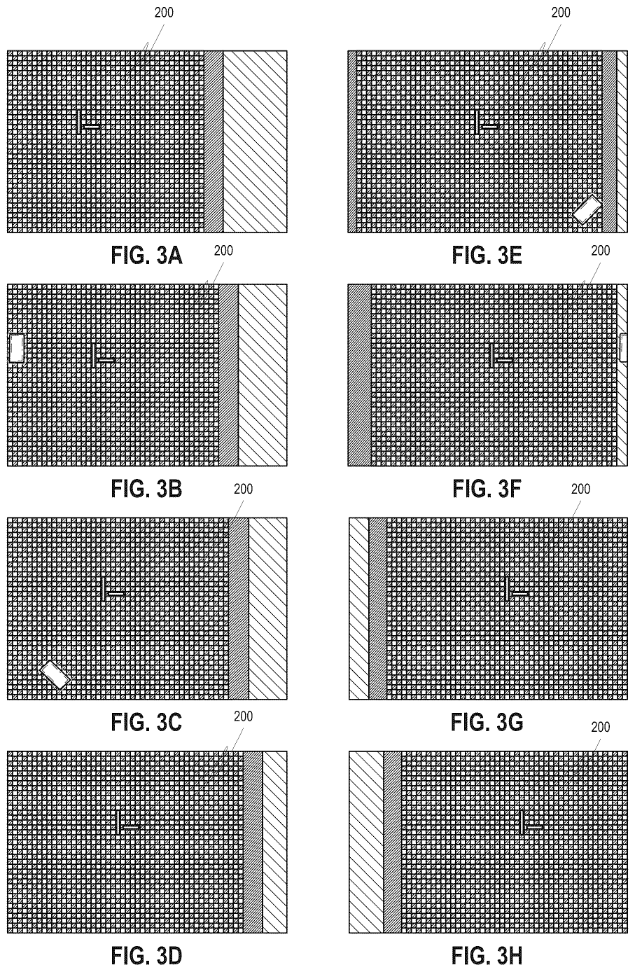

FIGS. 3A-3H are example images taken during a calibration of an inspection system using a calibration object 200, in accordance with an example embodiment. Here, each figure represents a different image taken at a different time under different lighting conditions, but each of the same calibration object 200 as it moves under the camera.

Once these images have been captured, in each image, the second-order derivative of image intensity is calculated, and the probable corner locations are identified as the peaks in the surface based on the second-order derivative. More specifically, in an image, the first-order derivative measures the rate of change of pixel intensity. The second-order derivative measures the rate of change of the first-order derivative, and is useful for detecting edges because zero-crossings (points where the second-order derivative sign changes) often correspond to edges. In an example embodiment, the second-order derivative can be approximated using a Laplacian operator.

A grouping (such as a 3×3 grouping) of corner locations with consistent spacing is found, and then the checkerboard is iteratively grown in all directions by searching for identified corners within small windows that would continue the existing identified checkerboard corners. This iterative process repeats until the edge of the image is reached or no peak is found in the search window that meets a threshold.

Once the corners of the calibration object have been determined, the distance and orientation of the calibration object can be determined. This may be performed using a camera calibration function that takes the detected corner locations from multiple images and returns parameters that describe lens distortions, as well as a camera matrix that describes the mapping between three-dimensional points and two-dimensional points. It also returns rotation vectors that describe the orientation of the calibration object relative to the camera. The camera calibration function operates by solving a system of equations that relate the three-dimensional coordinates of points in the calibration objects to their two-dimensional image coordinates. The function may also employ optimization techniques to refine the estimates of the camera parameters, and attempts to minimize re-projection error, which is the difference between the observed image points and the projected three-dimensional points.

Trigonometry can then be used to solve for the distance from the camera for the calibration object in each image, using the angular information about the lens that the camera calibration function provided and the known real-world size of the calibration object.

At this point, a single plane may be fit to the position/orientation of all observed calibration object images. Since the calibration object is moving within the same plane in which it lies, the orientation vectors for the calibration object can be averaged across all the images. Similarly, the shortest distance from the camera to the calibration object's plane can be computed in each image, and then the distance can be averaged across all images.

Additionally, observed movement in the images can be used to compute a movement vector within the conveyor plane. More particularly, now that the orientation of the conveyor plane has been determined, perspective warping of the image can be used to simulate a top-down view of the conveyor. For each pair of sequential images, this top-down view can be generated, edges detected in each image, and then the correlation within a range of offset values is used to find the movement vector that would optimally align the pixels with the top-down views.

The perspective warping can then be reversed, and the endpoints of that vector can be projected onto the conveyor plane to provide a three-dimensional movement vector. This movement vector can then be averaged across all the pairs of sequential images to get the direction of the final estimate for the movement vector. The timestamp difference between each pair of sequential images and the movement vector found between those images can be used to estimate the conveyor speed, and that speed estimate is averaged across all pairs to get the average conveyor speed.

Thus, all the images are sorted from earliest to latest timestamp and, for each pair of sequential images, the lens and conveyor calibration is used to project the pixels from the earlier image to three-dimensional coordinates on the conveyor belt plane, then move those three-dimensional coordinates along the calibrated movement vector by a distance determined by the calibrated speed and image timestamps, then reproject the three-dimensional coordinates back to the two-dimensional image.

In some example embodiments, after the time-based movement is determined, alignment is further improved by using Gaussian blurring and image derivatives to compute an edge surface for each image. For each pair of sequential images, the edge surfaces are correlated for all offsets within a small pixel radius. The location of maximum correlation indicates the two-dimensional offset vector for fine-tuning alignment. This two-dimensional offset vector is then projected onto the calibrated conveyor belt plane and then onto the calibrated movement vector. The length of this projected vector and the calibrated conveyor speed then provide a fine-tuned time offset for the first image of the pair. This proceeds through each pair of images, adjusting the timestamps to the fine-tuned value. The process from the time-based movement can then be repeated with the fine-tuned timestamps, to arrive at the final aligned images.

In some example embodiments, the above methods are run on a graphics processing unit (GPU) instead of a central processing unit (CPU). Several algorithmic decisions have to be made when running on a GPU instead of a CPU. Specifically, as mentioned above, Gaussian blurring is used. This is done instead of median filtering because, despite median filtering being more robust for illumination variance, it cannot be implemented on a GPU. Additionally, correlation is used instead of normalized-cross-correlation. Similarly, this sacrifices some quality on difficult images for speed.

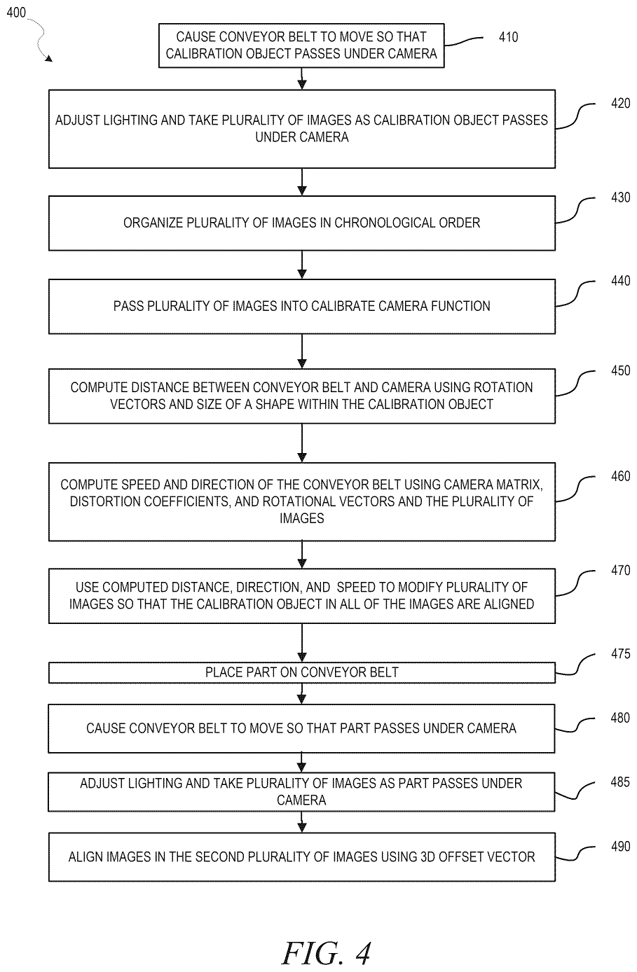

FIG. 4 is a flow diagram illustrating a method for aligning images taken of a part via a fly capture mechanism, in accordance with an example embodiment.

At operation 410, a conveyor belt is caused to move such that a calibration object passes under a camera. At operation 420, as the calibration object is passed under the camera, lighting from a lighting apparatus is adjusted and a plurality of images are taken from the camera of the calibration object under different lighting conditions.

At operation 430, based on timestamps associated with each image of the plurality of images, the plurality of images are organized in chronological order. At operation 440, the plurality of images are passed into a camera calibration function to obtain a camera matrix, distortion coefficients, and rotational vectors. The camera matrix defines a mapping of three-dimensional points to two-dimensional points. The distortion coefficients describe the amount of distortion in each of the plurality of images. The rotational vectors describe the amount of rotation of the calibration object in each of the plurality of images. The distortion coefficients describe the lens distortion in each of the plurality of images such that knowing the distortion coefficients allows for mapping of a pixel's coordinates in an image to a vector in 3D space.

At operation 450, a distance between the calibration object and the camera is computed using the rotation vectors and the size of the shape in the calibration object. At operation 460, speed and direction of the calibration object are computed using the camera matrix, distortion coefficients, and rotational vectors and the plurality of images. At operation 470, the computed distance, the computed speed, and the computed direction are used to modify the plurality of images so that the calibration object in all of the images are aligned in a single plane.

At operation 475, a part to analyze for defects is placed on the conveyor belt. At operation 480, the conveyor belt is caused to move such that the part passes under the camera. At operation 485, as the part is passing under the camera, lighting from the lighting apparatus is adjusted and a second plurality of images are taken from the camera under different lighting conditions. At operation 490, images in the second plurality of images are aligned using the three-dimensional offset vector.

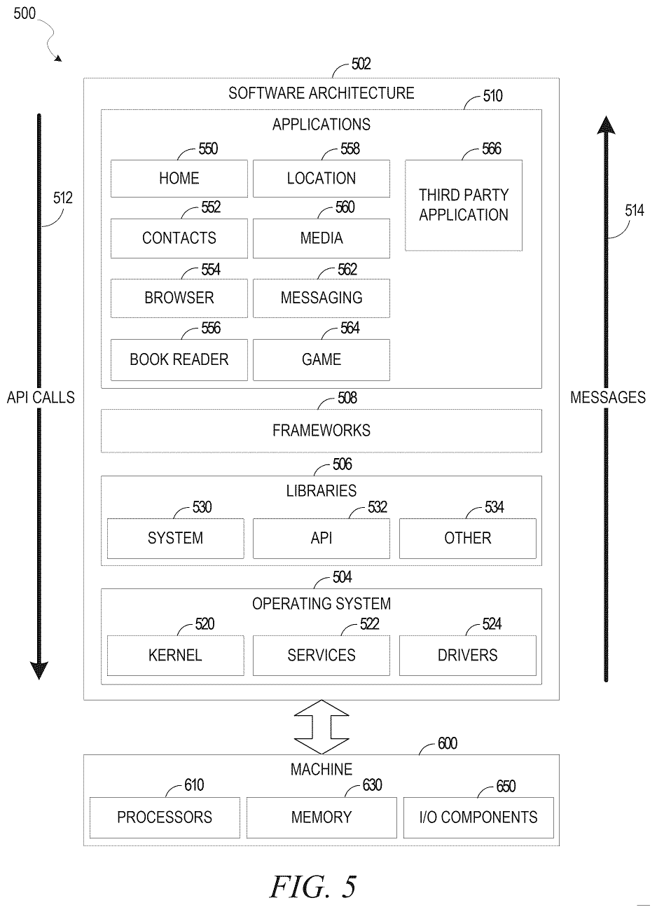

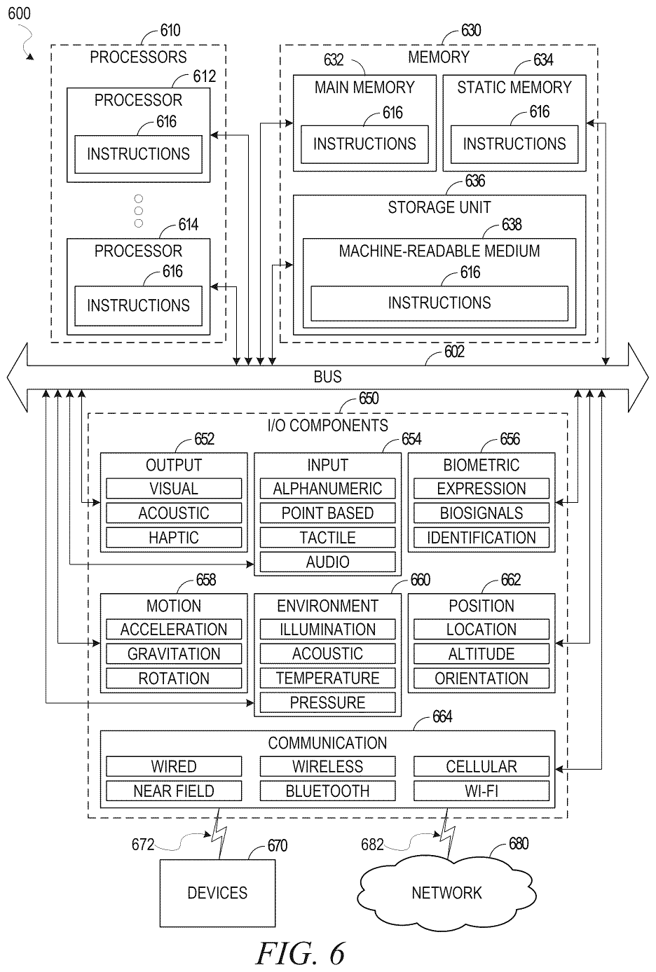

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke Application Program Interface (API) calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510. For example, the frameworks 508 provide various graphical user interface functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. The applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system.

FIG. 6 illustrates a diagrammatic representation of a machine 600 in the form of a computer system within which a set of instructions may be executed for causing the machine 600 to perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) cause the machine 600 to perform any one or more of the methodologies discussed herein to be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or include components operable to detect identifiers. For example, the communication components 664 may include radio-frequency identification (RFID) tag reader components, NFC smart tag detection components, optical reader components (e.g., an optical sensor to detect one-dimensional bar codes such as Universal Product Code (UPC) bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (i.e., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-readable medium” 638, “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 8G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., Hypertext Transfer Protocol (HTTP)). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

1. A system comprising:
a lighting apparatus comprising a plurality of lights;
a calibration object having a shape with a size;
a camera aimed at the conveyor belt;
a computer system comprising at least one hardware processor and a non-transitory computer-readable medium storing instructions that, when executed by the at least one hardware processor, perform operations comprising:
adjusting lighting from the lighting apparatus and taking a plurality of images from the camera of the calibration object under different lighting conditions;
based on timestamps associated with each image of the plurality of images, organizing the plurality of images in chronological order;
passing the plurality of images into a camera calibration function to obtain a camera matrix, distortion coefficients, and rotational vectors;
computing a distance between the calibration object and the camera using the rotation vectors and the size of the shape in the calibration object;
computing speed and direction of the calibration object using the camera matrix, distortion coefficients, and rotational vectors and the plurality of images;
using the computed direction and the computed speed to modify the plurality of images so that the calibration object in all of the images are aligned in a single plane.

2. The system of claim 1, wherein the operations further comprise:
for each image in the plurality of images:
computing a second-order derivative of image intensity of a corresponding image; and
identifying corners of the calibration object in a corresponding image based on the second-order derivative.

3. The system of claim 2, wherein the shape is a square with a checkerboard pattern.

4. The system of claim 3, wherein the identifying corners includes finding a grouping of corner locations with consistent spacing and then iteratively growing the calibration object in all directions by searching for corner locations within small windows that would continue the corner locations, until no peak in a search window meets a threshold or an edge of a corresponding image is detected.

5. The system of claim 1, wherein the operations further comprise:
for each pair of successive images in the plurality of images:
performing perspective warping on a first image of the pair of successive images to simulate a top-down view of the calibration object, based on the rotational vectors.

6. The system of claim 1, wherein the operations further comprise creating a three-dimensional offset vector using the aligned images.

7. The system of claim 6, wherein the operations further comprise:
causing a part to analyze to pass under the camera;
as the part is passing under the camera, adjusting lighting from the lighting apparatus and taking a second plurality of images from the camera under different lighting conditions; and
aligning images in the second plurality of images using the three-dimensional offset vector.

8. The system of claim 1 wherein the camera matrix defines a mapping of three-dimensional points to two-dimensional points.

9. The system of claim 1, wherein the distortion coefficients describe an amount of distortion in each of the plurality of images;

10. The system of claim 1, wherein the rotational vectors describe an amount of rotation of the calibration object in each of the plurality of images

11. A method comprising, at a controller:
causing a calibration object to pass under a camera;
as the calibration object is passing under the camera, adjusting lighting from a lighting apparatus and taking a plurality of images from the camera of the calibration object under different lighting conditions;
based on timestamps associated with each image of the plurality of images, organizing the plurality of images in chronological order;
passing the plurality of images into a camera calibration function to obtain a camera matrix, distortion coefficients, and rotational vectors;
computing a distance between the calibration object and the camera using the rotation vectors and the size of the shape in the calibration object;
computing speed and direction of the calibration object using the camera matrix, distortion coefficients, and rotational vectors and the plurality of images;
using the computed direction and the computed speed to modify the plurality of images so that the calibration object in all of the images is aligned in a single plane.

12. The method of claim 11, further comprising:
for each image in the plurality of images:
computing a second-order derivative of image intensity of a corresponding image; and
identifying corners of the calibration object in a corresponding image based on the second-order derivative.

13. The method of claim 12, wherein the shape is a square with a checkerboard pattern.

14. The method of claim 13, wherein the identifying corners includes finding a grouping of corner locations with consistent spacing and then iteratively growing the calibration object in all directions by searching for corner locations within small windows that would continue the corner locations, until no peak in a search window meets a threshold or an edge of a corresponding image is detected.

15. The method of claim 11, further comprising:
for each pair of successive images in the plurality of images:
performing perspective warping on a first image of the pair of successive images to simulate a top-down view of the calibration object, based on the rotational vectors.

16. The method of claim 11, further comprising creating a three-dimensional offset vector using the aligned images.

17. The method of claim 16, further comprising:
causing a part to analyze to pass under the camera;
as the part is passing under the camera, adjusting lighting from the lighting apparatus and taking a second plurality of images from the camera under different lighting conditions; and
aligning images in the second plurality of images using the three-dimensional offset vector.

18. A non-transitory machine-readable storage medium having embodied thereon instructions executable by one or more machines to perform operations on a controller comprising:
causing a calibration object to pass under a camera;
as the calibration object is passing under the camera, adjusting lighting from a lighting apparatus and taking a plurality of images from the camera of the calibration object under different lighting conditions;
based on timestamps associated with each image of the plurality of images, organizing the plurality of images in chronological order;
passing the plurality of images into a camera calibration function to obtain a camera matrix, distortion coefficients, and rotational vectors;
computing a distance between the calibration object and the camera using the rotation vectors and the size of the shape in the calibration object;
computing speed and direction of the calibration object using the camera matrix, distortion coefficients, and rotational vectors and the plurality of images;
using the computed direction and the computed speed to modify the plurality of images so that the calibration object in all of the images is aligned in a single plane.

19. The non-transitory machine-readable storage medium of claim 18, wherein the operations further comprise:
for each image in the plurality of images:
computing a second-order derivative of image intensity of a corresponding image; and
identifying corners of the calibration object in a corresponding image based on the second-order derivative.

20. The non-transitory machine-readable storage medium of claim 19, wherein the shape is a square with a checkerboard pattern.
